(19) United States
(12) Patent Application Publication
(10) Pub. No.: US 2017/0124834 A1
(43) Pub. Date: May 4, 2017

(54) SYSTEMS AND METHODS FOR SECURE COLLECTION OF SURVEILLANCE DATA

(71) Applicants: Maher Pedersoli, Tucson, AZ (US); Stephen Derek Ost, Scottsdale, AZ (US); Anthony Scott Hollars, Tucson, AZ (US)

(72) Inventors: Maher Pedersoli, Tucson, AZ (US); Stephen Derek Ost, Scottsdale, AZ (US); Anthony Scott Hollars, Tucson, AZ (US)

(21) Appl. No.: 15/349,858

(22) Filed: Nov. 11, 2016

Related U.S. Application Data
(63) Continuation-in-part of application No. 14/732,558, filed on Jun. 5, 2015.
(60) Provisional application No. 62/254,696, filed on Nov. 12, 2015.
(60) Provisional application No. 62/262,877, filed on Dec. 3, 2015.
(60) Provisional application No. 62/008,976, filed on Jun. 6, 2014.

(51) Int. Cl. G08B 21/02; G08B 27/00; H04N 7/18; G11B 27/34; H04M 3/42; H04W 4/22

(52) U.S. Cl. CPC G08B 21/0208; H04M 3/42059; H04W 4/22; H04N 7/185; G11B 27/34; G08B 27/001

(57) ABSTRACT

The present invention relates to systems and methods for the collection and sharing of surveillance data. This includes capturing video and audio data on a device, and providing this data to an operations center for additional analysis and/or sharing with other parties. Those other parties may notably include first responders, judicial entities, and auditing groups. In some cases, such as with first responders, the data may be shared in real time in order to improve operations and safety. The initialization of the data capture may be initiated by a user of the device capturing the data, via a dispatcher request, by request of the first responder, or by a peer device. Additional metadata gained from sensors or video frame signatures may be used for detecting tampering.

### CROSS REFERENCE TO RELATED APPLICATIONS

This application claims the benefit and is a non-provisional of U.S. Provisional Application No. 62/254,696 filed Nov. 12, 2015 entitled “Unique Identifiers per Videoset for Audio/Video Data Encryption/Decryption in a Live Streaming and or Recording by a Device Equipped with a Camera such as a Smartphone”, which application is incorporated in its entirety by this reference.

Additionally, this application claims the benefit and is a non-provisional of U.S. Provisional Application No. 62/262,877 filed Dec. 3, 2015 entitled “Systems and Methods for Secure Collection of Surveillance Data”, which application is incorporated in its entirety by this reference.

Lastly, this application claims the benefit and is a continuation-in-part of U.S. application Ser. No. 14/732,558 filed Jun. 6, 2014 entitled “Mobile Application for Instant Recording of Video Evidence”, which claims priority of U.S. Provisional Application No. 62/008,976 filed Jun. 6, 2014, which applications are incorporated in their entirety by this reference.

### BACKGROUND

The present invention relates to systems and methods for the secure collection, transfer and sharing of surveillance data. In particular, the present invention is centered on collecting information from a location or a user in an emergency situation. Such information may include video and/or audio data in addition to relevant metadata. The surveillance information may be shared with first responders and legal systems in order to improve bystander and first responder safety, improve first responder efficiency, and to enable more efficient investigation and prosecution of perpetrators.

The ability to record audio and video data has been present for many decades. Very early on it was found that collecting this surveillance data was particularly helpful in preventing criminal activity, and further during prosecution of criminals as integral evidence. As such, an entire field has developed around the manufacture and sale of recording devices for home and business use. These devices collect information, and typically capture it within a local storage device or within cloud storage. While effective, these systems have several drawbacks. First of all, they often are stationary (intended for site protection/surveillance). They often are also relatively expensive, as well as difficult to repair due to specialized hardware. Lastly, while these devices are often a good deterrent to criminal activity, and provide evidence after the fact, they don't typically allow for first responders to access the data being generated in real-time in order to improve response efficiency and/or increase safety.

More recently, surveillance has evolved due to the ubiquitous existence of mobile devices that have camera/video features. This allows for the instantaneous capture of evidence, and has resulted in a large number of recent cases and instances that have “gone viral” to the public, and have become staples of courtroom evidence. In response, there have likewise been a surge of “dash cams” and “body cams” within the market that are likewise capable of capturing video and/or audio data in emergency situations. While all these systems have benefits, they again are relatively limited use to first responders who are not yet “at the scene”. Further, video collected on standard mobile devices may be tampered with, resulting in concerns over its admissibility within a legal setting.

It is therefore apparent that an urgent need exists for systems and methods for secure collection, storage and sharing of surveillance data which is tamper resistant and balances the needs of privacy against those of safety. Such systems and methods will ultimately saves lives by allowing first responders to act more efficiently and with a greater degree of safety. Further, such systems and methods allow for an improvement in evidence handling, thereby resulting in shorter and more efficient trials.

### SUMMARY

To achieve the foregoing and in accordance with the present invention, systems and methods for collection, storage and sharing of surveillance data is provided. Such systems and methods allow first responders to act more efficiently and with a greater degree of safety. Further, such systems and methods allow for an improvement in evidence handling, thereby resulting in shorter and more efficient trials.

In some embodiments, the systems and methods for collecting surveillance data may include capturing video and audio data on a device, and providing this data to an operations center for additional analysis and/or sharing with other parties. Those other parties may notably include first responders, judicial entities, and auditing groups. In some cases, such as with first responders, the data may be shared in real time in order to improve operations and safety.

The initialization of the data capture may be initiated by a user of the device capturing the data, via a dispatcher request, by request of the first responder, or by a peer device, in some embodiments. When the user is initiating the surveillance capture, this may include an affirmative action, such as opening and initiating an application on the device, or may include any number of triggering events (inputs), which the user has configured to automatically initiate video recording. For example, a gunshot sound, scream, very fast acceleration, or rapid change in heart rate could all be indicators of an emergency and could initiate recording, in some embodiments.

In contrast, if a first responder requests that surveillance is captured and streamed, the user may be either asked for permission first, or alternate safeguards may be in place in order to prevent unwanted surveillance sharing. For example, if a local emergency system is active, or if the user's configurations allow for it, remote users may be able to gain access to surveillance data without explicit allowance by a user.

In some cases, it may be desirable to build tamper resistance into the captured surveillance data, especially when relying upon such data in a court or other evidentiary setting. Sensor data from the device, such as accelerometer data, orientation, gyroscope data, location data, microphone data and ambient lighting data may all be turned into metadata and appended to the surveillance information. Incongruities within this metadata provide evidence of tampering.

In some embodiments, the system running on a device is able to communicate with peer devices nearby in order to request additional capturing of surveillance data in an emergency situation. In addition to being able to capture more evidence, these simultaneous feeds allow first responders better information regarding the situation, and further can be cross referenced in order to ensure data fidelity.

Additionally, the system may be able to collect the surveillance information from the various streaming devices and analyze a large amount of information on backend servers in near real time. If the analysis includes image recognition, a person or object of interest may be identified, along with the approximate location (gained from the recording devices) in order to alert nearby first responders. This functionality is particularly powerful when paired with an AMBER alert type system where a notification is sent to a geographic area looking for a particular thing.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example block diagram of a first example surveillance environment where the surveillance apparatus is statically located for site-specific protection, in accordance with some embodiments;

FIG. 2 is a flow diagram illustrating an example process for allowing access to a surveillance data stream to first responders in a manner that ensures user privacy, in accordance with some embodiments;

FIG. 3 is an example block diagram of a second example surveillance environment where the surveillance apparatus is mobile/individualized, in accordance with some embodiments;

FIGS. 4A and 4B are flow diagrams illustrating example processes for ensuring tamper resistance to captured surveillance data, in accordance with some embodiments;

FIG. 5 is an example block diagram of a third example surveillance environment where the surveillance apparatus is mobile and capable of remote activation, in accordance with some embodiments;

FIGS. 6 and 7 are flow diagrams illustrating example processes for allowing on-demand access to a surveillance data stream within an emergency situation, in accordance with some embodiments;

FIG. 8 is an example block diagram of a fourth example surveillance environment where multiple mobile surveillance apparatus are operating within a geographic notification area, in accordance with some embodiments;

FIG. 9 is a flow diagram illustrating an example process for pushing amber alert notifications to relevant users, in accordance with some embodiments;

FIG. 10 is an example block diagram of a fifth example surveillance environment where multiple mobile surveillance apparatus are operating in peer-to-peer concert, in accordance with some embodiments;

FIG. 11 is a flow diagram illustrating an example process for improving event surveillance data collection utilizing multiple devices, in accordance with some embodiments;

FIG. 12 is an example block diagram of a sixth example surveillance environment where multiple mobile surveillance apparatus are operating in tandem with a government security agency to identify objects or people of interest, in accordance with some embodiments;

FIG. 13 is a flow diagram illustrating an example process for crowd sourced identification of objects or people of interest, in accordance with some embodiments;

FIG. 14 is a flow diagram illustrating an example process for unorthodox activation of surveillance, in accordance with some embodiments;

FIG. 15 is a block diagram illustrating example components of a representative mobile device or tablet computer (e.g., category controller, maintenance controller, etc.) in the form of a mobile (or smart) phone or tablet computer device; and

FIGS. 16A and 16B are example computer systems capable of implementing the system for improving wireless charging, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The presently disclosed systems and methods are directed toward the improved collection, storage and sharing of surveillance data. As previously noted, current mechanisms of collecting audio and video data are often vulnerable to tampering, thereby lessening their effectiveness as evidence within a judicial setting. Further, as these systems tend to operate in silos, such systems and methods improve upon current mechanisms by providing live streaming of important surveillance data to first responders in a manner that protects users' privacy. By allowing first responders to have access to this data, they may approach the situation better prepared, and with a greater degree of safety than otherwise possible.

The term “device” as used herein is intended to refer to any device with which is capable of capturing surveillance data. Often these devices are also referred to as “mobile devices” or “mobile appliances” as one focus of such surveillance collection is with devices such as laptops, cell phones, and tablets. However, it should be understood that any device where a camera, microphone r other applicable sensor falls within the scope of the term “device”. This includes stationary security camera systems and the like.

Likewise, while this disclosure relates to “emergency situations” and the presence of “first responders” it may be understood that these terms may mean very different things based upon the scenario where these systems are deployed. For example, such systems could be configured for use by a neighborhood watch, and the ‘first responders’ could be concerned citizens rather than firefighters and police. In alternate situations, such as in a disaster zone or combat situation, the ‘first responders’ may include military personnel or other non-civilian entities. First responders may also include private medical or security forces based upon application.

Lastly, note that the following disclosure includes a series of subsections. These subsections are not intended to limit the scope of the disclosure in any way, and are merely for the sake of clarity and ease of reading. As such, disclosure in one section may be equally applied to processes or descriptions of another section if and where applicable.

I. Sharing of Surveillance Data from a Static System

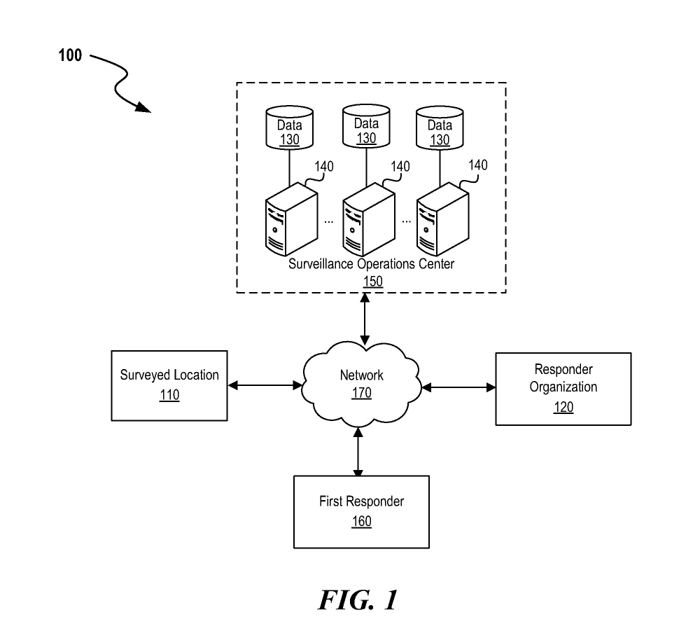

To facilitate this discussion, FIG. 1 is an example block diagram of a one example surveillance environment where the surveillance apparatus is statically located for site-specific protection, shown generally at 100. Throughout this disclosure, various surveillance environments shall be presented that differ in key ways in order to specifically identify aspects of the invention that may be implemented in some embodiments. It should be noted however, that these situations are not necessarily mutually exclusive, and in many embodiments it is natural to combine multiple features into a single system. For example, it may be beneficial to allow for the present static location system to be combined with mobile peer-to-peer ‘crowd sourcing’ of data collection, as will be discussed in greater detail below. Indeed, in some embodiments it may be possible to incorporate all of the disclosed features into a single system. As such it is strongly cautioned that no section of the present disclosure is taken in isolation, but rather is understood to merely be focusing on particular system features for the sake of clarity.

In the presently illustrated environment 100, the surveyed location 110 is seen interfacing with a network 170. The network 170 may be any type of cellular, IP-based or converged telecommunications network, including but not limited to Global System for Mobile Communications (GSM), Time Division Multiple Access (TDMA), Code Division Multiple Access (CDMA), Orthogonal Frequency Division Multiple Access (OFDM), General Packet Radio Service (GPRS), Enhanced Data GSM Environment (EDGE), Advanced Mobile Phone System (AMPS), Worldwide Interoperability for Microwave Access (WiMAX), Universal Mobile Telecommunications System (UMTS), Evolution-Data Optimized (EVDO), Long Term Evolution (LTE), Ultra Mobile Broadband (UMB), Voice over Internet Protocol (VoIP), Unlicensed Mobile Access (UMA), etc.

The network 170 can be any collection of distinct networks operating wholly or partially in conjunction to provide connectivity between the surveyed location 110, a surveillance operations center 150, and various first responders 160 and responder organizations/base stations 120. In some embodiments, communications to and from the surveyed location 110, a surveillance operations center 150, and various first responders 160 and responder organizations/base stations 120 can be achieved by, an open network, such as the Internet, or a private network, such as an intranet and/or the extranet. Surveyed location 110, a surveillance operations center 150, and various first responders 160 and responder organizations/base stations 120 can be coupled to the network 170 (e.g., Internet) via a dial-up connection, a digital subscriber loop (DSL, ADSL), cable modem, wireless connections, direct fiber connections and/or any other types of connection.

In some embodiments the surveyed location may be any residence, business or public space where surveillance is desired. Generally this location includes places where a surveillance system would already be present. For example, most banks and high end retailers already have systems that collect video and/or audio information, and include alarm systems that may be triggered by employees in order to summon the police in the event of an emergency. Likewise, many home security systems also include video surveillance, and often these systems may send an alert to the police or fire department (either directly or through a third party service provider) in the event of an emergency.

The first responders 160 are typically police, paramedics, fire officials and the like; however, as previously discussed these first responders may be situation dependent, and may include private security/safety/fire/medical groups, military or paramilitary forces, concerned citizen groups, or the like. Likewise, the responder organization 120 may include operations centers for these first responders 160, including the fire department and police department, for traditional first responders, as well as mobile command centers, private responder organizations, etc.

The surveillance operations center 150 includes a plurality of servers 140 and data centers 130 for storing and coordinating surveillance information. Any number of servers 140 and/or data repositories 130 may be included with surveillance operations centers 150. The databases 130 can be implemented via object-oriented technology and/or via text files, and can be managed by any database management system. The surveillance operations center 150 can include various learning systems and/or algorithms. For example, the surveillance operations center 150 can provide supervised learning (or machine learning systems) which can leverage classification algorithms to identify items based on criteria, and can be trained with more data and refinement of results, etc. Examples of usage include, by way of example and not limitation, pattern and image recognition. Additionally, the surveillance operations center 150 can provide unsupervised learning leverage Clustering algorithms to identify patterns/trends in data, etc. This pattern recognition may be particularly beneficial for automated surveillance to identify objects or people of interest, as will be discussed in greater detail in following sections.

In some embodiments, the surveyed location may collect surveillance data via cameras, microphones, or any other suitable sensors. Generally, for the purposes of this disclosure, ‘surveillance data’ refers to video and audio data; however, this is not an inclusive listing of what may constitute surveillance data. For example, in some cases it is possible that only video data is captured. In alternate embodiments other data types may be captured, such as infrared (heat) signatures, radar, sonar, magnetic/induction readings (such as from a metal detector), subsonic-vibration data, electromagnetic data (such as radio frequency transmissions), etc. Clearly, depending upon sensory input, and desired purpose, the surveillance data collected may vary considerably from one situation to the next. However, for the sake of simplicity, for the bulk of this disclosure, particular attention will be focused on video data, even though it is understood that the present systems and methods may apply to a much broader set of data inputs.

Returning to FIG. 1, surveillance data is collected by local systems at the surveyed location 110. This data may be stored locally, or in some embodiments may be provided to the surveillance operations center 150 for remote storage within data stores 130. This data may be stored indefinitely, or may be stored for a shorter period of time based upon use case. For a retailer, for example, it may be beneficial to keep video data for anti-theft purposes for a six month period, in some cases. A bank however, for audit reasons, may require a longer retention period. In contrast, a homeowner may wish for data to be kept for far shorter periods based upon privacy concerns.

Generally the collected data is kept private and secure. However, if an emergency situation arises, an individual at the surveyed location 110 may trigger an alert that is sent to the surveillance operations center 150. In turn the surveillance operations center 150 may forward live streaming data on to the responder organization 120 and relevant first responders 160. This surveillance data allows responders to know more about the situation they are entering in advance. This allows the responders to deploy appropriate resources, and enter the situation tactically.

For example, assume the surveyed location 110 is a bank, and a robbery is currently underway. Video data shows responders that a single gunman has taken money and is escaping from the building's rear entrance. Rather than confronting the perpetrator within the building, it may be preferable to capture the individual upon exit of the building in order to minimize the likelihood that a bystander is injured. In contrast, assume there are multiple heavily armed gunmen, and the situation has evolved into a hostage situation. In such cases, additional resources may be allocated (such as SWAT, hostage negotiators, air support, etc.).

Presently, most banks and similar institutions include the ability to collect surveillance data. They also have the ability to alert first responder of an emergency situation via a ‘panic button’ or similar notification system. However, the marriage of these systems in such a manner that allows for the seamless provisioning of live streamed surveillance information to first responders is unprecedented.

In some embodiments, the following disclosed system may be enabled via a wireless router located within the surveyed location 110. In such embodiments, the wireless router may be activated in an emergency situation in order to stream the locally collected surveillance, and send it to a central communication tower/node. The wireless tower then forwards the surveillance data to the surveillance operations center 150. The surveillance operations center 150 may have a wired and/or wireless connectivity to the responder organization 120. In some embodiments, the responder organization 120 determines which relevant first responders 160 to provide the data to.

In some embodiments, rather than have an individual at the surveyed location 110 initiate the live streaming of the surveillance information to the first responders, the responder organization may request, from the surveillance operations center 150, to have access to the information. This request may be granted in the instance where an emergency (9-1-1) call has been placed, or when the emergency alert from the location has been triggered (e.g., fire alarm, panic button, etc.). If there is no record of an emergency situation, in some embodiments the surveillance operations center 150 may reject access to the surveillance live stream, thereby ensuring that privacy concerns are addressed.

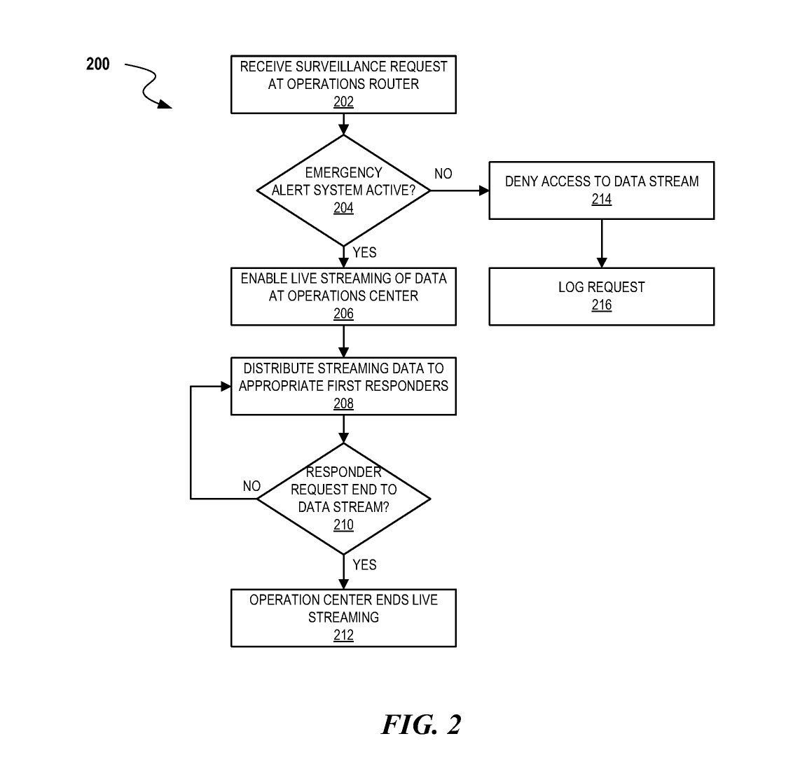

FIG. 2 is a flow diagram 200 illustrating an example process for allowing access to a surveillance data stream to first responders in a manner that ensures user privacy, as briefly noted above. In this example process, a surveillance request from the police, fire department, or other suitable responder entity is received by at an operations router, at 202. This router may be an appliance locally positioned within the surveyed location. The router inquires whether an emergency alert system is currently active for the location where surveillance is being requested, at 204. Since the router is also local to the surveyed location, it may be in direct communication with other local alert systems on site in order to make the determination of whether an emergency situation is present.

If so, then the system may enable live streaming of the surveillance data from the surveyed location to the surveillance operations center, at 206. In turn, the surveillance operations center may pass along the streamed live data to appropriate entities, including relevant first responder operations centers, at 208, or even directly to particular first responders, in some embodiments. In alternate embodiments, the responder operations centers (e.g., police department) may forward the live surveillance data to the appropriate first responders. At any time the responder entity may request an end to the data stream, at 210. Alternatively, the system may automatically end data streaming after a lapse of sufficient time, r in the event that it is proactively disabled at the site (re-engagement of the fire alarm for example).

Regardless of the trigger, upon discontinuation, the surveillance operations center may end the streaming of the surveillance data to the responders, at 212. Likewise, if there was never an emergency situation in the first place, the router may immediately deny access to the surveillance data stream, at 214, and the request for access may be logged, at 216. Frequent or suspicious false requests for access may cause a notification to a system administrator to look into the reason(s) that responder organizations are incorrectly requesting access to surveillance data.

II. Tamper Resistant Collection of Surveillance Data

In addition to allowing for surveillance information to be collected from systems tied to a single location, the presently disclosed surveillance capturing and sharing system enables every day users to leverage their portable devices to capture and share important surveillance data in emergency situations. Examples of devices may include cell phones, smart watches, go-pro® or other ‘action’ camera systems, tablets, laptops, and the like. Generally, and device that includes imaging or other data collection capability may be leveraged as a means for collecting, storing and sharing surveillance information.

One major drawback of utilizing common devices for surveillance collection is that the data collected is not necessarily as secure as data collected from purpose-built surveillance systems. Images and video on a phone, for example, may be tampered with or otherwise altered. As this data is increasingly being leveraged within courtrooms as evidence, this has resulted in an explosion of cost associated with verifying the accuracy of any cell phone video or similar data. In some cases, actual evidence may even be thrown out as not meeting the strict criteria of the court's evidence rules. Thus, there is a very strong need for a personal surveillance mechanism that is tamper resistant, and thus admissible within a courtroom.

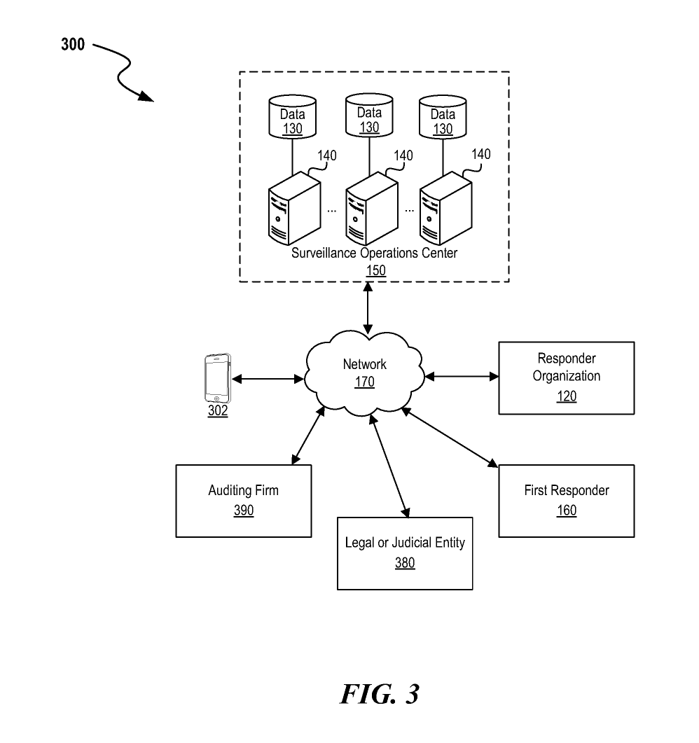

FIG. 3 is an example block diagram of a second example surveillance environment where the surveillance apparatus is mobile/individualized and allows for tamper resistant data captures, shown generally at 300. Such a system enables the collection and storage of surveillance data with metadata incorporated in order to easily determine if the data has been tampered or altered. Similar to the previously disclosed environment, the current system likewise includes a surveillance operations center 150 including servers 140 and data stores 130. The surveillance operations center 150 couples to a network 170 which in turn is coupled to a responder organization 120 and first responder 160, as in the previous environment. However, in this embodiment, the system also includes a legal/judicial entity 380 and auditing firm 390 which may also gain access to the surveillance data. The legal entity may include a court, defense attorney, prosecutor, or disciplinary board, or the like. The auditing firm 390 may be tasked with performing verification of the surveillance data.

In this system, the surveillance data is being collected on a mobile device 302, which may include a smartphone, go-pro style action camera, tablet computer, laptop, digital camera, built-in vehicle camera, or other suitable device type. As with the previous embodiments, the surveillance data typically includes video and audio data, but may include additional data types depending upon device capability. The mobile devices are capable of collecting additional data, such as acceleration, ambient light, orientation and the like. This additional data may be compiled as metadata and appended to the surveillance data in order to generate a signature. Incongruities in the signature may indicate that the surveillance data has been tampered with, and thus allow for higher standards of evidence validity.

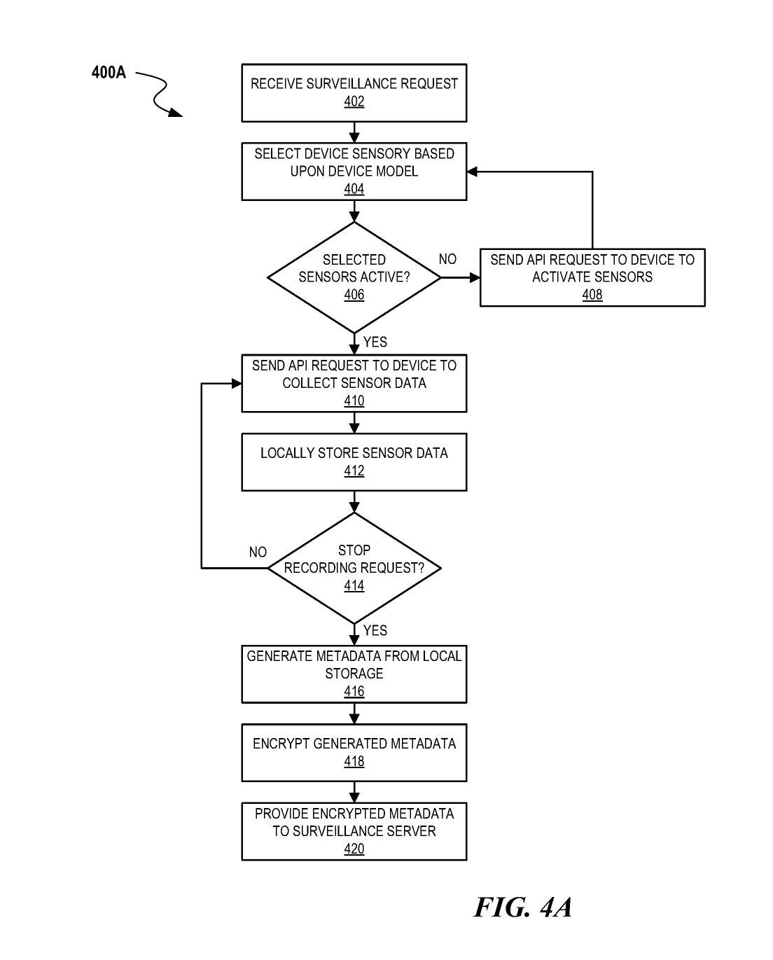

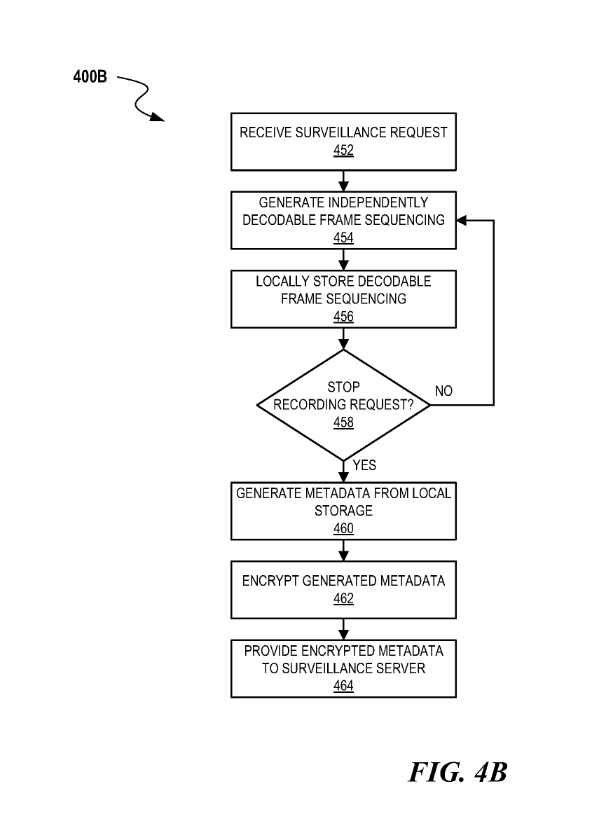

FIGS. 4A and 4B are flow diagrams illustrating example processes for ensuring tamper resistance to captured surveillance data, in accordance with some embodiments. In particular, FIG. 4A provides a first flow diagram 400A where acceleration and other sensor data are incorporated into the surveillance metadata. This example process begins with the receipt of a surveillance request, at 402. The application that captures the surveillance data then makes a determination of which sensors to incorporate into the signature based upon the device model, at 404. Since different mobile devices may include different capabilities, the most reliable and tamper resistant sensor data may be employed depending upon the device in use. The sensor data typically utilized may include accelerometer data, gyroscope data, and magnetometer data (broadly defined as motion sensors); GPS data, cellular tower triangulation data, and network based services (broadly defined as location data); and ambient light sensors, microphone information, proximity sensors and infrared sensors (broadly defined as ambient sensors). In some cases, the device may be able to leverage all these data sources, thereby generating a metadata set that is highly tamper resistant. In other cases fewer data sources may be relied upon.

For example, in a smartphone that is being used to capture audio/video live stream, it is known that each pixel of a camera's optical sensor has a small but measurable bias. This bias is a linear function of the actual intensity of light hitting the pixel. By using the camera identification, using the pixels' bias, it is possible to create a unique fingerprint for the camera during the audio/video streaming or recording per each individual dataset/frame. Using this fingerprinting technique, it is further possible to associate a dataset/frame with the smartphone that is used to capture the audio/video stream. In an alternative embodiment, the use of smartphone hardware specification of its microphone and speakers may be utilized to generate fingerprinting data from the frequency response graph. A smartphone microphone's frequency response is its normalized output gain over a given frequency range. Conversely, a smartphone speaker's frequency response is its normalized output audio intensity over a given frequency range. A typical smartphone microphone or smartphone speaker has a response curve that varies across different frequencies. These variations are dependent on the hardware design of the audio device inside the smartphone. In one varying embodiment, the lack of manufacturing inconsistencies across smartphone speakers and microphone hardware is used to generate fingerprinting data and associate it with each dataset/frame. It is known that the frequency responses of each instance of a microphone or a speaker are not identical even if they are of the same model. In smartphones, the microphone and speaker response for each frequency has a tolerance relative to the response specified by the manufacturer. A typical tolerance for low-end microphone and speakers is ±2 db. These variances in the frequency responses are used to generate fingerprinting data and correlated to a specific smartphone device. An audio/video live streaming application can play tones in certain frequencies using the device's speakers while at the same time record the played audio using the microphone. This allows the mobile application in a smartphone to measure the frequency responses of the speakers and microphones. Moreover, other imperfections, aside from the offset and sensitivity may be created due to inconsistencies in the manufacturing process. A mobile application of smartphone can read measurements from these sensors; thereby calculating their imperfections, which are then used in fingerprinting live audio/video stream.

In other embodiments, the use of smartphone location sensors may be used for fingerprinting live audio/video streams. As an example, a GPS receiver triangulates the location of a device by calculating its distance to at least 3 GPS satellites. The distances are calculated by measuring the time a signal travels from a satellite to the GPS receiver. The travel time is measured using an inaccurate clock built into the GPS receiver. It is known that a clock's skew can identify the clock. In addition, there are sources of errors while calculating the receiver's position, such as atmospheric effects and multi-path effects. Because such errors are not taken into account during the position determination and are implicitly treated as error sourced by the clock bias, this may lead to a position calculation where the clock bias is not perfectly corrected. By taking multiple location measurements from the GPS, the bias will be exposed and can be used in fingerprinting live audio/video stream.

The method next determines if the selected sensors are active, at 406. If not the application sends an API request to the device in order to activate the desired sensors, at 408. Once the sensors are active, the application sends an API request to the device to collect data from the sensors, at 410. The sensor data is then stored locally, at 412. The method continually monitors for a stop request for surveillance recording, at 414. Once the stop request is made, the application generates metadata from the locally stored storage of collected sensor data, at 416. This metadata is then encrypted, at 418, and provided to the surveillance server for audit and surveillance verification purposes, at 420. In some embodiments, the collected sensor data is time stamped and correlated to the surveillance data collected at the same time. Incongruities found in the collected sensor data may indicate that the surveillance data has been altered or edited, thereby allowing for verification of data integrity.

FIG. 4B provides a second mechanism for generating tamper resistant surveillance data, shown generally at 400B. This method may be performed instead of, or in addition to the previously discussed method of utilizing sensory data. In this example process, the surveillance request is again received, at 452. Next the method generates independently decodable frame sequencing, at 454. Since a video sequence consists of frames of images stitched together at a rate known as frames per second (FPS), following three dimensional objects across frames allows for the fingerprinting of the video stream. Having frames at a high FPS rate enables a video sequence to appear to the human eye as continuous motion. Detecting a 3D object in beginning or an end of a frame enables the generation of confidence by looking at subsequent frames. Once a 3D object is recognized as part of a dataset (like cars, people, motorcycles, frogs, etc.), the next task is to be able to track it as it moves. The movement in such case consists of displayed motions. This means that the 3D object will display different poses and prospective. Since a video recording might have multiple 3D objects, there is a high probability that the 3D objects can obstruct each other. This brings the opportunity to use approximate data, such a nearest neighbor search on the image features paired with extracted metadata of the 3D object features, to encode a specific dataset or metadata to reference a frame in the video recording that is used in fingerprinting a live audio/video stream. In addition, the metadata can be formed of key points assigned as one or more orientation data, based on the image various directions. This frame sequencing may be stored locally, at 456, until a stop recording request is received, at 458.

After the surveillance is ended, the application may generate metadata from the locally stored frame sequencing, at 460. This metadata may again be encrypted, at 462, and provided to the surveillance server for verification purposes, at 464.

III. Remote Initiation of Data Sharing

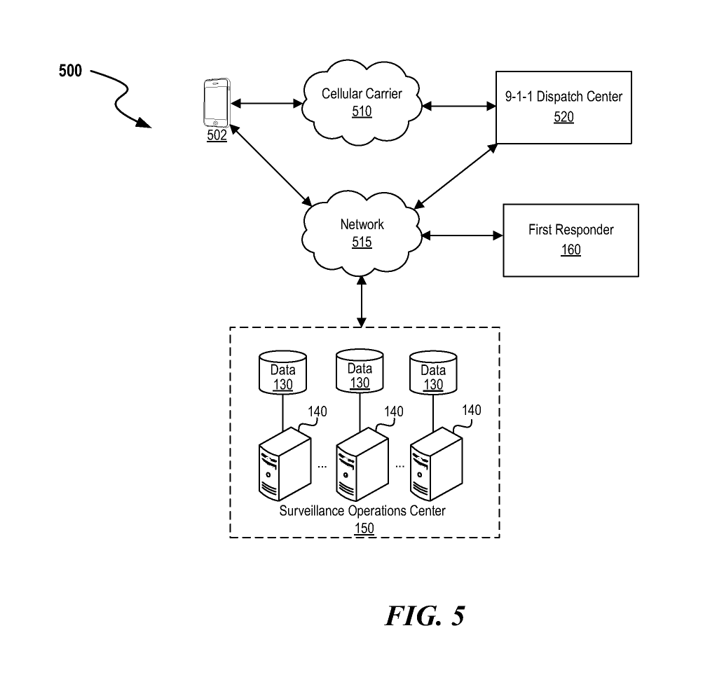

Moving on, FIG. 5 provides an example block diagram of a third example surveillance environment 500 where the surveillance apparatus is mobile and capable of remote activation, in accordance with some embodiments. In this particular embodiment, the network is being specifically called out into various subcomponents for clarification purposes. In particular, this example environment is particularly tailored to a mobile device used with cellular connectivity, such as a smart phone. The smartphone 502 may connect to a cellular carrier 510, and is typically relied upon when making a phone call. In the event the user dials an emergency number (traditionally 9-1-1 in the United States), the call is immediately routed to an emergency dispatch center 520, where the dispatcher collects information regarding the nature of the emergency in order to ensure proper resources are deployed. Generally a dispatcher requires information regarding the location of the emergency, type of emergency, and urgency of the emergency. This information is usually collected via a conversation, but this has various drawbacks. For example, the caller may be unclear of important facts. Alternatively, the user may be confused, disoriented, injured or in shock, thereby limiting their ability to effectively communicate with the dispatcher.

The present system overcomes these intrinsic hurdles, by allowing mobile devices with this functionality installed to allow for remote access by an emergency dispatcher once a 9-1-1 call has been initiated. The dispatcher 520 may receive the caller's ID and may access the surveillance operation center's 150 database 130 in order to do a comparison of the callers ID against known enabled users. If a match is made, the dispatcher may send a request for access to the live surveillance data. Based upon the user's preferences and configurations, this data may be supplied to the dispatcher, which may assist in determining which first responders 160 to deploy. Additionally, the dispatcher may be able to allow forwarding of the live surveillance to the first responders as well, as previously discussed. In addition to surveillance data, the dispatcher, in some embodiments, may gain access to location data collected by the device, thereby allowing for faster responder service.

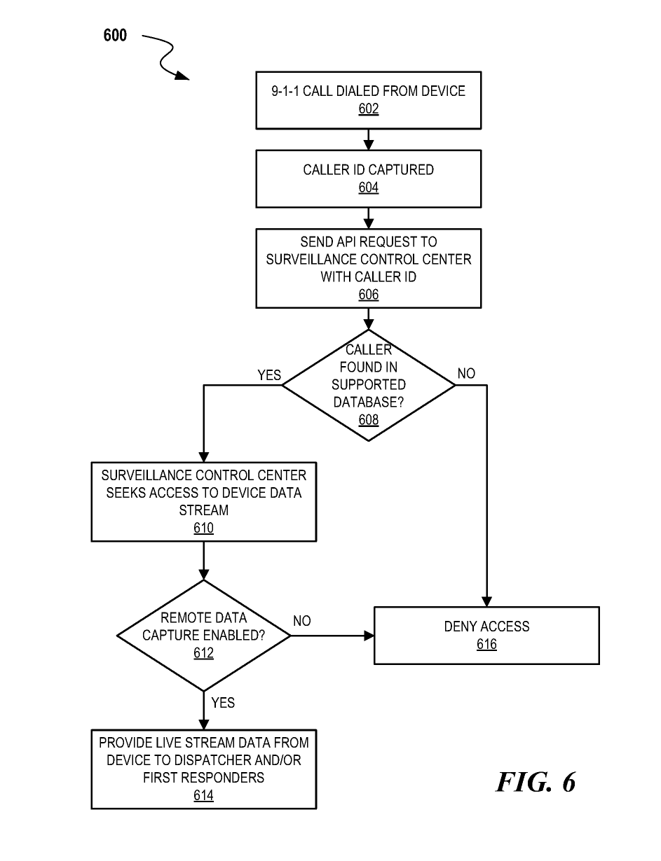

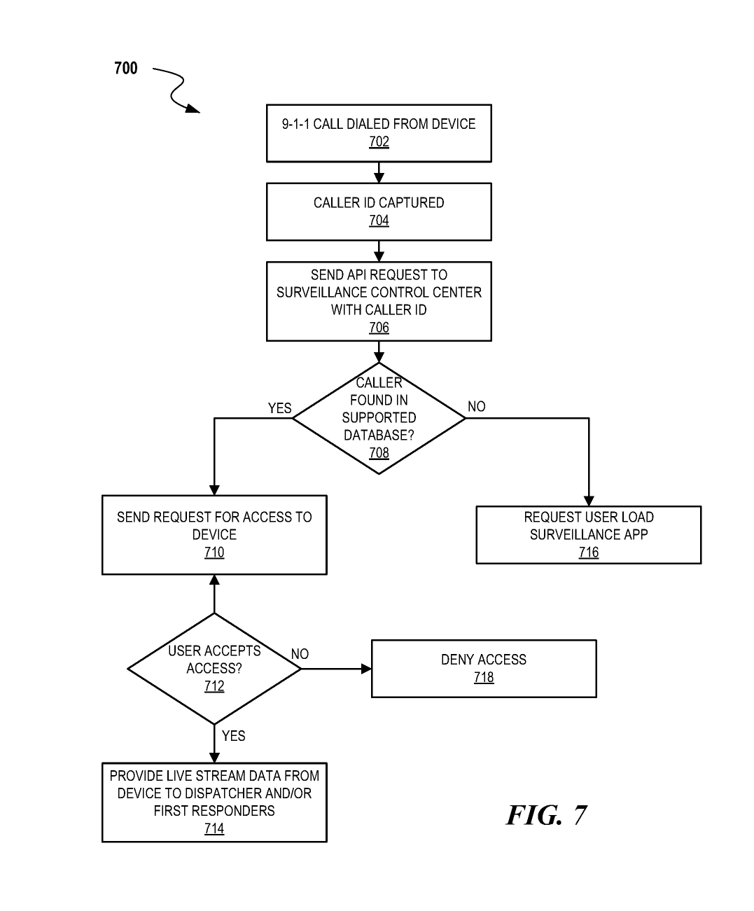

FIGS. 6 and 7 are flow diagrams illustrating example processes for allowing on-demand access to a surveillance data stream within an emergency situation, in accordance with some embodiments. In FIG. 6, the example process 600 starts with the user making a 9-1-1 call from the device, at 602. The caller's ID is captured, at 604, and an API request is sent to the surveillance control center with the caller ID, at 606. In some embodiments, the application on the device may initiate this request with the surveillance control center, and in alternate embodiments the dispatcher may send such request.

If the caller is found in the database of supported devices, at 608, the surveillance control center may seek access to the live stream of device surveillance data, at 610. The next stage is to determine if remote initiation of data capture is enabled for the user/device, at 612. If so, then the live streamed data may be provided from the device to the dispatcher and/or first responders, at 614.

If however, the user is not found within the surveillance control center's dataset, or if their configurations are set to denying remote data capture, then the method may instead deny access to any collected data, at 616. The ability for a user to configure their system to deny remote initiation of data sharing is an important privacy feature. It allows a given user to tailor the degree to which they prioritize security versus privacy.

FIG. 7 provides an alternate example process whereby live streamed surveillance data may be remotely accessed by a third party, shown generally at 700. As with the previous example process, here a 9-1-1 call is first dialed from the device, at 702, and the caller ID is captured, at 704. Likewise, an API request is sent to the surveillance control center with the caller ID, at 706. This is where the two example processes diverge.

In this process, if the caller is found in the supported database, at 708, the system may send a push notification request for access to the device, at 710. This allows the user to affirmatively initiate the sharing rather than it automatically commence based upon user configurations. If the user accepts the request, at 712, the live stream of surveillance data is provided to the dispatcher and/or first responders at 714. However, the user may alternatively deny the request, thereby denying surveillance access to the dispatcher, at 718.

Returning to where the determination is made whether the device is supported, in this example process, if the device is found to not be supported, rather than simply reject the surveillance request downright, in this example method, a request may be sent to the user to download the surveillance application to allow the dispatcher access to data streams, at 716. In such embodiments, the downloaded program may be a “lite” version in order to facilitate rapid download. This version may include limited functionality in favor of being able to be rapidly loaded onto the user's device in order to very quickly providing surveillance data to the dispatcher. Over time, this limited version may be replaced, or expanded via updates, to include the full version of the surveillance capturing system disclosed herein.

IV. Targeted Notifications

In addition to being able to capture tamper resistant surveillance data, and allowing for remote connectivity by a third party, some embodiments of the surveillance application may allow for geographically dependent notifications that tie into already established emergency response systems. One such system already utilized is the AMBER Alert system, which provides a mechanism to notify law enforcement and citizens across jurisdictions of child abductions, or events of missing persons. In the case of an abduction, the initial few hours are critical, with successful recovery of the person diminishing significantly within a short amount of time. The AMBER Alert system was initially instituted in order to ‘crowd source’ surveillance for a missing person or suspect vehicle. This program has been very successful in assisting in the recovery of missing persons.

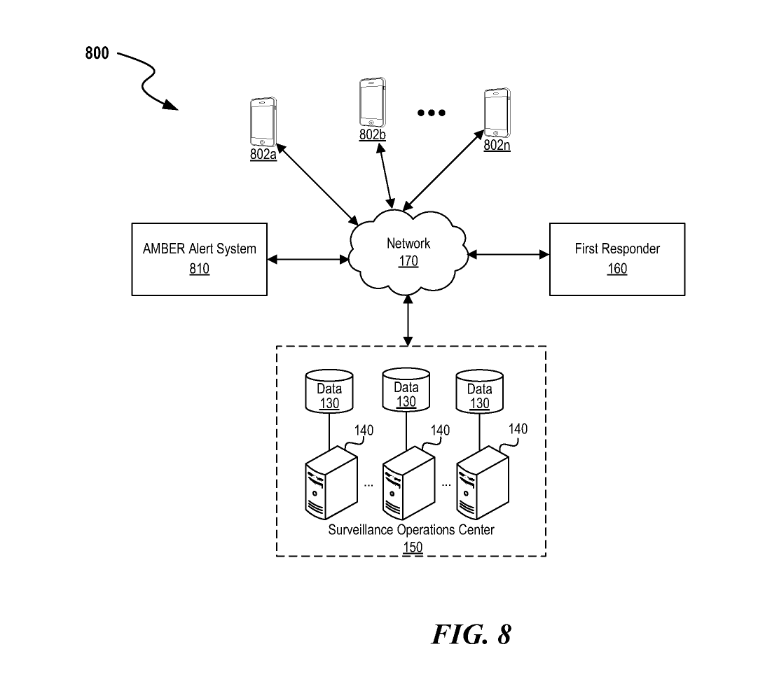

FIG. 8 is an example block diagram of a fourth example surveillance environment 800 where multiple mobile surveillance apparatus are operating within a geographic notification area, in accordance with some embodiments. Such systems may work with the AMBER Alert system 810, or any other suitable alert system. Many user devices 802a-n may be operating within the geographic area of interest. These devices 802a-n may include any number of device types, including integrated vehicle camera and alert systems, smartphones and the like. The devices 802a-n, the AMBER Alert system 810, first responders 160, and the surveillance control center 150 may all couple to one or more networks 170.

In a typical response situation, the AMBER Alert system 810 is made aware of a situation very rapidly from local law enforcement or other agency. The AMBER Alert system 810 notifies first responders in the relevant area, and also provides text or phone information to citizens who have signed up for AMBER alerts. Generally an AMBER Alert includes a geographic limitation where the abduction occurred, and also includes descriptive information regarding the abducted person and/or suspect (vehicle make/model, physical description, etc.).

In the circumstance when a user 802 with the surveillance capturing system is present is also able to receive AMBER Alerts, upon receipt of an alert, the surveillance application may convey the alert to the surveillance control center 150 including the geographic limitations of the alert. The surveillance control center 150 may in turn push the notifications to other users within the geographic location that have surveillance capturing capabilities.

In some embodiments, where the devices 802a-n include vehicle systems with integrated cameras, the system may be further enabled to allow for remote triggering of video/audio data capture. Location information may also be streamed. In some cases the surveillance control center 150 may include sophisticated image recognition capabilities, which allow for the identification of specific objects. In some advanced embodiments, a user may receive an AMBER alert on a smartphone, which is then provided to the surveillance control center 150 through the surveillance capture system. Vehicles with cameras in the affected geography may be notified and their cameras remotely initiated. The collected live data is processed by the surveillance control center 150 to identify a suspect, child, or vehicle of interest. Upon a match, the surveillance control center 150 may provide the location and image to a nearby first responder. Such systems enable far more efficient and capable monitoring of public roads, and ultimately increases the chances of rescuing an abduction victim.

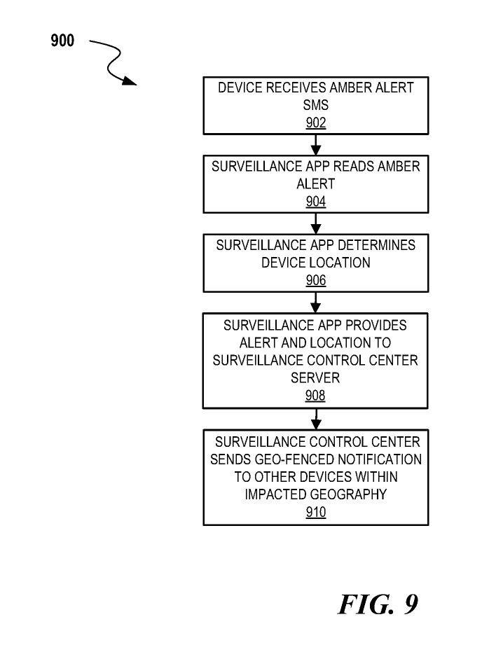

FIG. 9 is a flow diagram illustrating an example process 900 for pushing amber alert notifications to relevant users, in accordance with some embodiments. In this example process, initially a device receives an AMBER alert notification, at 902. Subsequently the surveillance application located upon the device reads the AMBER alert, at 904, and determines device location, at 908. Device location may be extrapolated from cell tower triangulation, GPS coordinates, and/or wireless services.

Subsequently, the surveillance application provides the alert information, as well as the device location, to the surveillance control center, at 908. The surveillance control center may then send a geo-fenced notification to other devices within the impacted geography, at 910.

V. Multiple Device Data Collection

Already touched upon in the previous section is the concept that input into a first device may result in further sharing or even activation of other devices through the surveillance control center 150. In some instances, a user might wish to share one or more videos with other users. A user, using the surveillance application's settings, can create a group. A group on the surveillance application can be, for example, friends, workmates, family, and/or law enforcement task force, neighborhood watch, and community policing groups or gang/drug activity reporting groups.

A user can invite other users to join an existing group, using a surveillance application ID, phone number, or email address. A user can also receive an invite to join one or more groups created by other surveillance application users. surveillance application can alert a user of one or more pending invitations to join one or more groups. An invitation alert to join a group can be received using a mobile push notification alert, a phone call, or SMS text message. In addition, users can option-in to join one or more existing groups by searching for one or more groups based on one or more predefined criteria. Predefined criteria, can be, but not limited to, evidence category, location proximity, social network connection, relationships, device type, emergency type, age group, demographics, residence, car type, purchase history, previously visited location, calendar entry, hotel reservation, vacation reservation, vacation stays, transportation route, GPS direction, email groups, phone records, online activity, among others. A user might option-in to sync their phone and online calendar with surveillance application to ease the process of inviting others to join one or more groups.

One or more users can belong to one or more groups. When user ‘A’ selects to join group G1, user ‘A’ can share previously recording videos with group G1, or select to share, in real-time audio/video stream with group G1. User A can also share the same with one or more groups at the same time, such as, group G2, G3, G4, etc. A user can select, using the surveillance application's privacy settings, the type or category of videos to share with one or more groups. Each user in a group can attach other data and information, such as but not limited to, description, photos, evidence type, evidence category, etc. A user or a group of users may option to select a group leader, who will have higher authority to manage the group. The leader authority, might include, but not limited to, removal of users, addition of users, remove evidence link, add attachments, remove attachment links, etc. In addition to the above, a user might option-in, using the surveillance application's settings, to automatically join a group based on a system criteria and user preferences. A user might option to join groups on certain date or time interval. A user may option to receive videos and live stream-sharing requests at certain time of the year, day, or night.

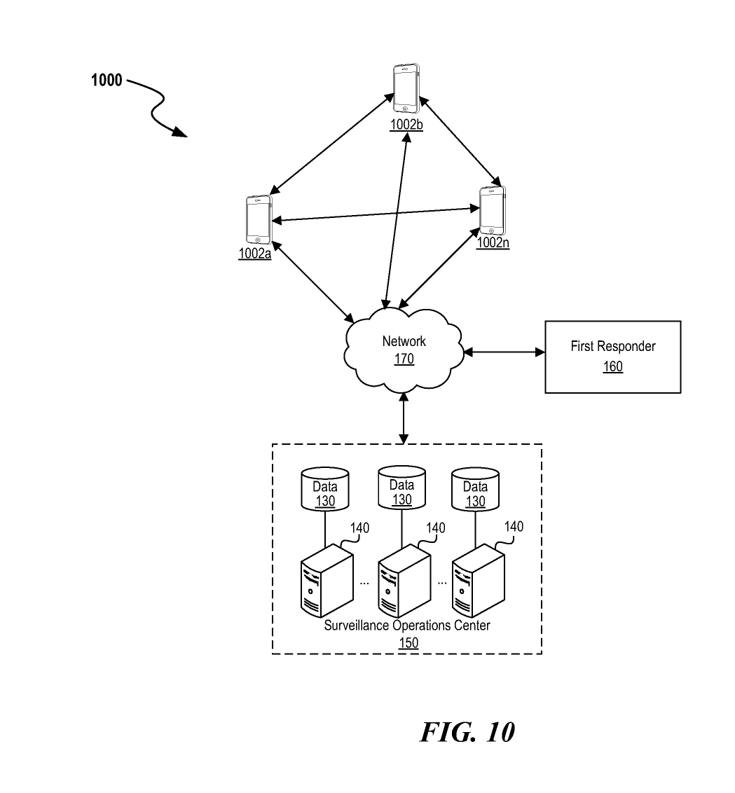

In FIG. 10, an expansion of that theme is provided where the devices are not only capable of influencing each other through an intermediary, but also are capable of directly influencing one another through direct sharing of surveillance information, or conversely remotely activating one another. In this example diagram, a fifth example surveillance environment 1000, where multiple mobile surveillance apparatus are operating in peer-to-peer concert, are provided in accordance with some embodiments.

Here the various devices 1002a-n are still seen as being capable of interacting with the surveillance control center 150 via the network 170, but may also be capable of direct peer-to-peer communication. This direct communication has various advantages: for example, once a single device is notified of an emergency other nearby users may be made aware of the emergency situation. This may result in a more orderly response by individuals, and may speed evacuations or other activities where a crowd must act in concert. Further, such peer-to-peer notifications may allow for one surveillance system, upon activation, elicit other devices to likewise start capturing surveillance data. This may give first responders a much more complete idea of the nature and scope of the emergency event, and further provide a much more inclusive data set for subsequent evidence and post mortem activity.

For example, multiple data feeds of a single event may be cross referenced in order to detect any incongruities or other evidence of tampering. Thus these surveillance feeds may provide self-verification of one another within a court or other tribunal. Further, by collecting data from different angles and directions, a more complete picture of the scene may be extrapolated. Lastly, having multiple devices recording an environment may enable even more advanced surveillance screening, when coupled with image recognition systems, to detect threats or identify persons or objects of interest.

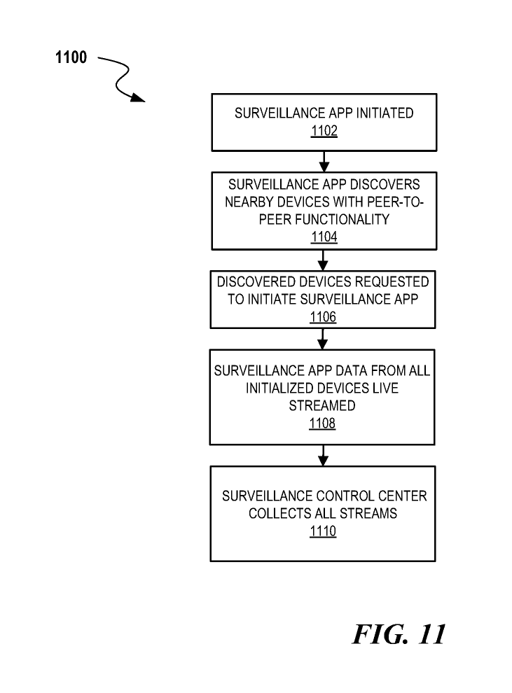

FIG. 11 is a flow diagram illustrating an example process 1100 for improving event surveillance data collection utilizing multiple devices, in accordance with some embodiments. In this example process, the surveillance application is first initialized on a device, at 1102. In this example process, the surveillance application leverages the device communication systems to discover nearby devices, at 1104. For example most mobile devices include short-range wireless radio frequency communication, such as Bluetooth communication protocols. The discovered devices may be requested to initiate their surveillance application in turn, at 1106.

This request may be routed to the user, in the form of a popup request screen, or may merely query the application settings in order to determine if remote application from peer devices is enabled. Regardless, in this example at least some of the devices where the request is made are capable of complying, resulting in a plurality of surveillance feeds from one locale. These surveillance streams are then all live transmitted to the surveillance control center, at 1108, where they are collected and either stored for evidence, analyzed (as will be discussed below), or forwarded on to the appropriate first responders.

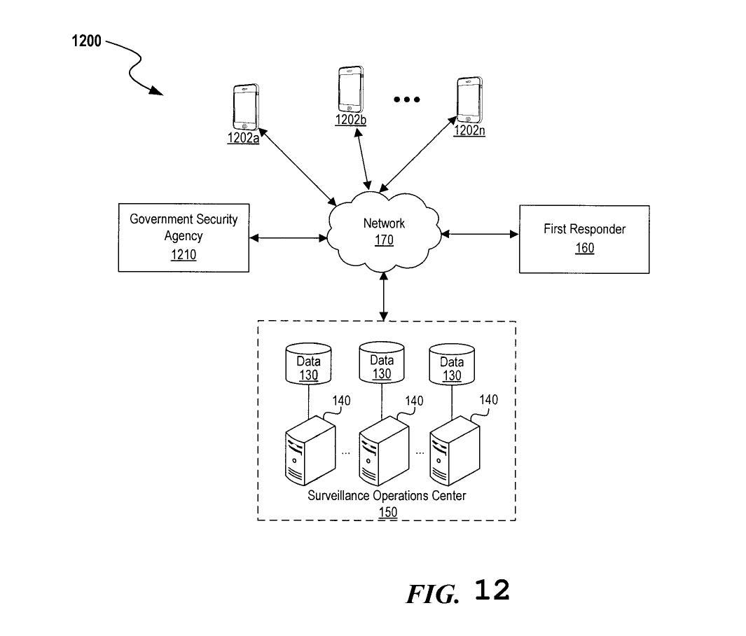

FIG. 12 is an example block diagram of a sixth example surveillance environment 1200, which is closely related to the previous system, where multiple mobile surveillance apparatus 1202a-n are operating in tandem with a government security agency 1210 to identify objects or people of interest, in accordance with some embodiments. The devices 1202a-n, the government security agency 1210, and the surveillance operations center 150 all connect via the network. In this embodiment, the government security agency 1210 provides the surveillance operations center 150 with some sort of object or person of interest. Rather than having a government entity parse through the surveillance feeds, for privacy reasons, it may be preferable for the surveillance operations center 150 to undergo all analysis of the data feeds from the individual devices.

The surveillance operations center 150 may leverage known image recognition, voice matching, and facial recognition software, across a host of servers 140, in order to identify possible candidate matches to the object(s)/person(s) of interest. Upon a close match, the system may record the location of the device which collected the surveillance data, and provide this information to a relevant first responder 160.

In some cases it is beneficial to perform the image or audio recognition analysis in real time (or close to real time) and route first responders who are very close to the device in order to minimize latencies. This helps prevent the loss of a subject, and the rapid response to an object of interest.

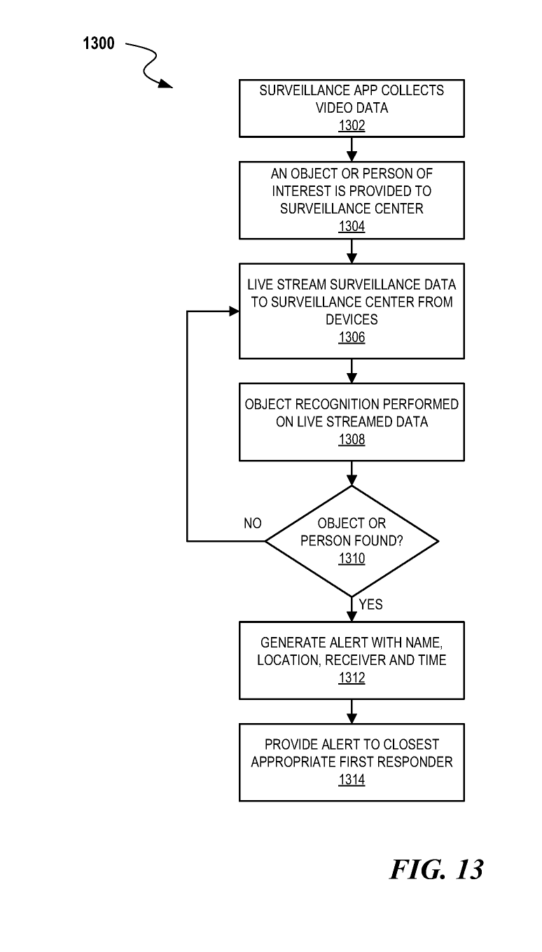

FIG. 13 is a flow diagram illustrating an example process 1300 for crowd sourced identification of objects or people of interest, in accordance with some embodiments. As noted above, this example process begins with the surveillance application of many devices collecting video, or other suitable surveillance information, at 1302. Likewise, the object or person of interest is provided to the surveillance operations center, at 1304. The captured surveillance data is live streamed to the surveillance operations center form the devices, at 1306 and object recognition analysis is performed on the live streams, at 1308. This continues unless or until the object is found, at 1310. Once the object or person of interest is identified, an alert is generated, at 1312. The alert may include the name of the object or person of interest, location where the surveillance data was collected, time and receiver information. In some cases the alert may even include a clip or screenshots of the captured surveillance data. The alert is then provided to the closest first responders of appropriate type, at 1314. For example, if the object of interest is a bomb, for example, the police bomb squad may be alerted first, even if other first responders are closer to the object of interest.

VI. Emergency System Activation

With all this focus on emergency situations, it is naive to assume that a user is always capable of initiating the presently disclosed systems and methods using conventional means. A cell phone is often locked for example, and requires the input of a password or pin in order to access. Further, once open, the appropriate icon for the surveillance application must be located. For many users, this may include sifting through literally hundreds of applications. Hopefully the user is not utilizing the surveillance application often, due to having a very peaceful and content life, thus most users are likely unfamiliar with the applications location or even the basic interface. All this can take time and concentration, which are both often in short supply during an emergency situation.

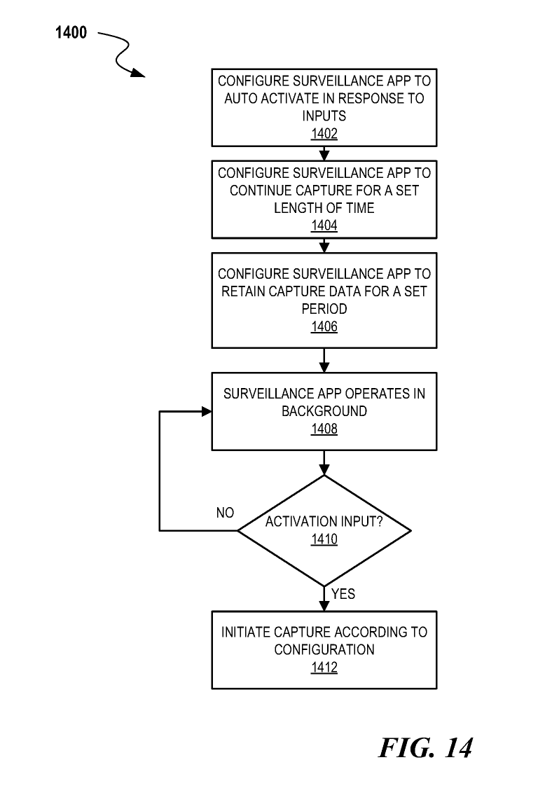

Further, this does not even consider that the user may be incapacitated or disoriented by the emergency, or may wish to not alert another person that the surveillance is occurring. For all these reasons, it is beneficial for some embodiments of the presently disclosed surveillance system to become active in response to non-traditional inputs. FIG. 14 provide one flow diagram illustrating an example process 1400 for unorthodox activation of surveillance, in accordance with some embodiments.

In this example process the user first configures the surveillance application to auto-activate in response to various inputs, at 1402. These may include any input type, but a few are more common to emergency situations and may be presets within the systems configuration screen. Examples of auto-activation inputs may include, but are certainly not limited to, noises such as screams, gunshots, sobbing, or predetermined “safe” words. These safe words may be codes known to the user that may be used to initiate surveillance without raising suspicion of others. For example a user may set the system to initiate when uttering the term “pomegranate.” If the user speaks such a term, the system will be triggered to initiate without tipping anyone off. In addition to various sounds, other inputs could be used to trigger auto-activation. For example very rapid accelerations, specific device movements, rapid heart rate increases, or the like, could all be used as a trigger for system activation.

In some instances, a user might not be aware of certain emergencies that require a user to record and live audio/video stream to the surveillance operations center servers. The system, described here, enables a mobile device, such as smart phone, to trigger the surveillance capture functionality of recording via live-stream to a server when one or more conditions are met. A user can enable this autopilot mode in the surveillance application's settings. In some embodiments, this autopilot mode receives commands from back end servers on when and where to start capturing real time video streams. The system may be based on one or more self-learning machine methods, using user's smart phone device sensors to adopt to, and learn, the user's interaction and behavior, in order to predict the need to trigger a video streaming action. For example, the system, using user's smartphone device sensors, can understand and learn when a user is, for example, scared, happy, sleep, driving, at work, or on a vacation. In addition, surveillance application streaming functionality can be triggered automatically based on input from external devices such wearable devices that can report physiological responses. An example when a person first becomes aware of a potentially dangerous or in a frightening situation. An example is well-documented fight or flight response, which has a very unique signature of physiological responses such and rapid heartbeat rate change and other measurable responses. These instant changes could be collected by the sensors in the smart phone itself or collected via wearable devices paired with a smartphone. External devices include but not limited to such as a smart watch, fitness tracker bracelets, or other dedicated device worn or carried in close proximity to the body that can detect a persons physiological changes.

Moreover, the system, using smart prediction of dangerous situation, might trigger and alarm a user of certain dangerous situations. For example, the system may interact with nearby devices such car's GPS, or other apps running on the user's smart phone, and warn the user of an emergency situation that could be happing on a specific route or destination. One example of such would include when a bank robbery is identified taking place at a location identified as a user's destination. Other examples can be a home invasion, fire, or a robbery happing in real-time where the location is identified by the system as a user's destination.

The system can also predict an emergency, alert a user, and auto trigger surveillance recording functionality using input from other nearby or connected devices or peripherals such as wearable watches, vehicles automotive sensors, or other nearby wired or wireless devices.

After setting the trigger inputs, the user must also configure the length of surveillance capture, at 1404, and retention time for the data that has been captured, at 1406. Often there will be false positives to the set inputs in hopes that when an actual emergency is occurring the system will be properly initiated. By setting the capture period and retention time the device memory is not overly burdened by too much stored data. In the event that an actual emergency is recorded, the user may always have the option of saving the recorded surveillance data.

After the system has been thus configured, the surveillance application may operate within the background, at 1408, until the activation input is received, at 1410. At this stage the device may begin capture of the surveillance data in the manner configured, at 1412.

VII. System Embodiments

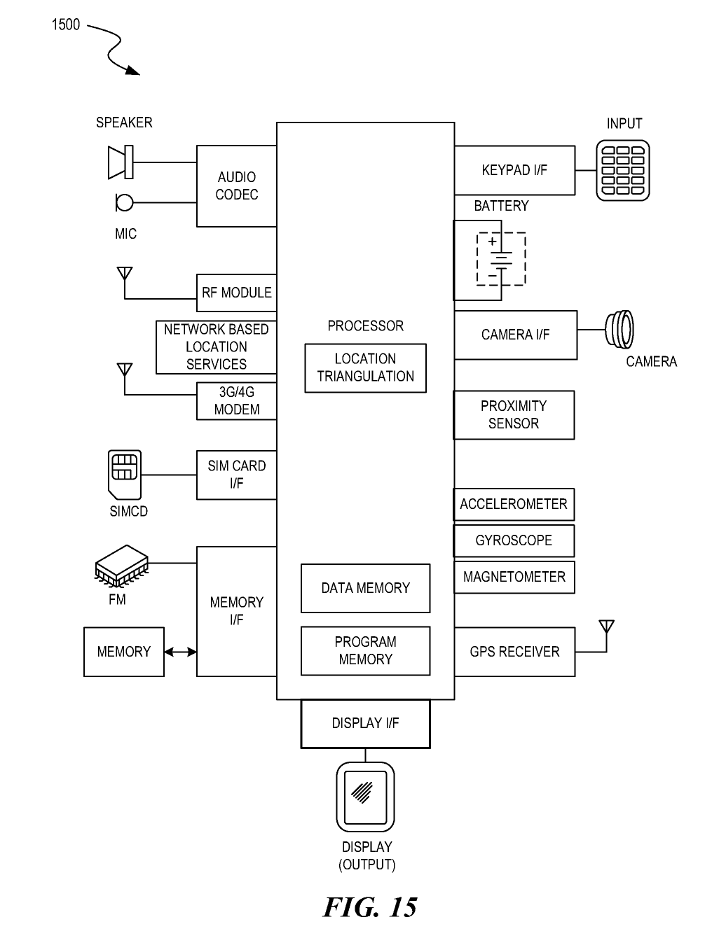

Now that the systems and methods for the capture, storage and sharing of surveillance data has been described in considerable detail, attention will be turned to various examples of embodiments of the system being employed. To facilitate this discussion, FIG. 15 depicts a block diagram illustrating example components of a representative mobile device or tablet computer 1500 in the form of a mobile (or smart) phone or tablet computer device. Various interfaces and modules are shown with reference to FIG. 15, however, the mobile device or tablet computer does not require all of modules or functions for performing the functionality described herein. It is appreciated that, in many embodiments, various components are not included and/or necessary for operation of the surveillance capturing system. For example, components such cellular radios, and biometric sensors may not be included in the device to reduce costs and/or complexity. Additionally, components such as ZigBee radios and RFID transceivers, along with antennas, can populate the Printed Circuit Board, in some embodiments.

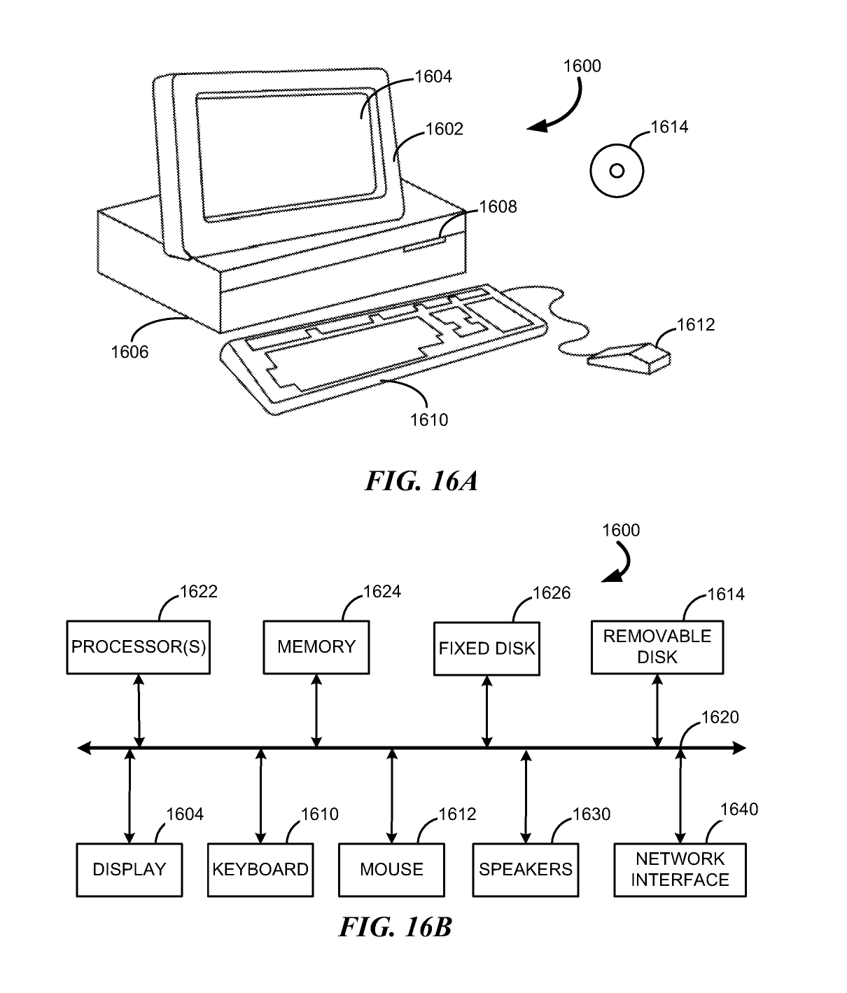

Lastly, FIGS. 16A and 16B illustrate a Computer System 1600, which is suitable for implementing embodiments of the present invention. FIG. 16A shows one possible physical form of the Computer System 1600. Of course, the Computer System 1600 may have many physical forms ranging from a printed circuit board, an integrated circuit, and a small handheld device up to a huge super computer. Computer system 1600 may include a Monitor 1602, a Display 1604, a Housing 1606, a Disk Drive 1608, a Keyboard 1610, and a Mouse 1612. Disk 1614 is a computer-readable medium used to transfer data to and from Computer System 1600.

FIG. 16B is an example of a block diagram for Computer System 1600. Attached to System Bus 1620 are a wide variety of subsystems. Processor(s) 1622 (also referred to as central processing units, or CPUs) are coupled to storage devices, including Memory 1624. Memory 1624 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 1626 may also be coupled bi-directionally to the Processor 1622; it provides additional data storage capacity and may also include any of the computer-readable media described below. Fixed Disk 1626 may be used to store programs, data, and the like and is typically a secondary storage medium (such as a hard disk) that is slower than primary storage. It will be appreciated that the information retained within Fixed Disk 1626 may, in appropriate cases, be incorporated in standard fashion as virtual memory in Memory 1624. Removable Disk 1614 may take the form of any of the computer-readable media described below.

Processor 1622 is also coupled to a variety of input/output devices, such as Display 1604, Keyboard 1610, Mouse 1612 and Speakers 1630. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 1622 optionally may be coupled to another computer or telecommunications network using Network Interface 1640. With such a Network Interface 1640, it is contemplated that the Processor 1622 might receive information from the network, or might output information to the network in the course of performing the above-described surveillance capture, analysis and streaming. Furthermore, method embodiments of the present invention may execute solely upon Processor 1622 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 1600 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

In sum, the present invention provides systems and methods for the capture, sharing, analysis and usage of live streamed surveillance data. Such systems and methods enable the more efficient and safer operation of first responders, improved detection of persons or objects of interest, improved evidence within a courtroom, and increased personal safety.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

What is claimed is:

1. A method for collecting surveillance data in an emergency situation, implemented on a device, comprising:
enabling video and audio capture in response to an emergency situation;
generating metadata from sensors on the device for each frame of the captured video and audio; and
providing the captured video and audio information to an emergency responder in real time.

2. The method of claim 1, wherein the emergency situation is determined by user activation of a surveillance application on the mobile device.

3. The method of claim 1, wherein the emergency situation is determined by an emergency dispatcher over a cellular connection.

4. The method of claim 1, wherein the emergency situation is determined by a peer device or a server sharing information regarding an ongoing emergency situation.

5. The method of claim 1, wherein the metadata includes at least one of measurements of ambient lighting, accelerometer data, gyroscopic data, digital compass data, connection strength, watermarking, fingerprint data, and an abstracted signature of an object in motion.

6. The method of claim 5, wherein the metadata is encrypted.

7. The method of claim 5, further comprising verifying authenticity of the captured audio and video using the metadata using a matching algorithm.

8. The method of claim 1, further comprising:
performing image recognition to match the captured video to an object or person of interest; and
sending a notification of the match to the emergency responder.

9. The method of claim 8, wherein the emergency responder is selected based upon responder type and physical proximity to the device.

10. The method of claim 1, further comprising cross referencing captured video and audio from more than one device to verify the authenticity of the captured video and audio.

11. (canceled)

12. (canceled)

13. (canceled)

14. (canceled)

15. (canceled)

16. (canceled)

17. (canceled)

18. (canceled)

19. (canceled)

20. (canceled)

21. A method for collecting surveillance data in an emergency situation, implemented on a device, comprising:
initiating an emergency phone call to a dispatcher system;
providing a caller ID to the dispatcher system;
receiving a request from the dispatcher system for surveillance data;
capturing video and audio information; and
providing the captured video and audio information to at least one of the dispatcher system and an emergency responder, in real time.

22. The method of claim 21, wherein the dispatcher system is reached via a cellular call to 9-1-1.

23. The method of claim 21, further comprising accessing user configurations to determine if the request is denied.

24. The method of claim 21, further comprising prompting a user to accept or deny the request.

25. The method of claim 21, further comprising logging the request.

26. A method for brokering surveillance data in an emergency situation, comprising:
receiving a request from an operations router for surveillance data from a surveyed location;
inquiring if an emergency alert system is active at the surveyed location;
denying and logging the request if the alert system is inactive;
enabling live streaming of the surveillance data to an operations center if the alert system is active; and
terminating the live streaming upon request from a first responder.

27. The method of claim 26, wherein the first responder is police.

28. The method of claim 26, wherein the first responder is fire department.

29. The method of claim 26, wherein the first responder is medical personnel.

30. The method of claim 26, wherein the first responder is paramilitary.

31. The method of claim 26, wherein the first responder is a citizen group.

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
